(19) United States
(12) Patent Application Publication
(10) Pub. No.: US 2012/0182415 A1
(43) Pub. Date: Jul. 19, 2012

(54) Pattern Matching Method, Pattern Matching Program, Electronic Computer, and Electronic Device Testing Apparatus

(75) Inventors: Yasutaka Toyoda, Mito (JP); Mitsuji Ikeda, Hitachinaka (JP); Yuichi Abe, Mito (JP)

(73) Assignee: Hitachi High-Technologies Corporation, Minato-ku, Tokyo (JP)

(21) Appl. No.: 13/499,983

(22) PCT Filed: Oct. 4, 2010
(86) PCT No.: PCT/JP2010/067364

§ 371 Date: Apr. 3, 2012

(30) Foreign Application Priority Data
Oct. 5, 2009 (JP) 2009-231428

(51) Int. Cl. H04N 7/18

(52) U.S. Cl. 348/80; 348/E07.085

(57) ABSTRACT

Disclosed is a pattern matching method whereby a testing point can be searched accurately while simplifying the work of presetting. An image region of a part of a captured image is extracted, and a divided image of the image region is set as a template image. A pattern matching is performed by rotating the template image. Moreover, the pattern matching determines whether a point-symmetric pattern exists inside the image region.

### TECHNICAL FIELD

The present invention relates to a pattern matching method of searching testing points, programs of the method, an electronic computer for executing the method and an electronic device testing apparatus providing the electronic computer, used for a circuit pattern test in electronic devices.

### BACKGROUND ART

In recent years, the high density integration for semiconductor devices has been progressed to improve a performance of the devices and reduce a manufacturing cost. For a purpose of performing a test for such semiconductor devices, there have been used with a semiconductor testing device and a semiconductor measuring device making use of an optical microscope and an electron microscope.

These devices provide pattern matching means of searching patterns for a test purpose and for specifying the testing point from a captured image of an electronic device, as means of accurately capturing the testing point on the electronic device.

There exist various pattern matching techniques. Generally, the test for electronic devices uses a method of searching the pattern matched with a template from the captured image of electronic device by an image processing, at a stage of the test. In this case, it is required to prepare the captured image of the pattern for specifying the captured testing point prior to the test or design data corresponding to that pattern, as a template, in advance.

The pattern to be used for specifying the testing point of the electronic device uses a center of region at which scribe lines on silicon wafer are intersected with each other, a basal plate mark (crisscross-shaped) of printed-circuit board etc., and a point at which a pattern becoming a point symmetry centering around a certain point exists.

There have been known art as indicated below, as a realization technique of the pattern matching to be targeted for searching the above-described point-symmetric pattern.

### SUMMARY OF INVENTION

### Technical Problem

In a technique disclosed in Japanese Published Examined Application No. 8-12050, an image containing the point-symmetric pattern should be set in advance, as a template or reference image becoming a criteria for searching the testing point. For this reason, it becomes difficult to accurately search the testing point when the setting is improper.

In a technique disclosed in Japanese Published Unexamined Application No. 2001-291106, when a part of the point-symmetric pattern becoming the criteria for searching the testing point exists outside a region of a captured screen, it becomes also difficult to accurately search the testing point since it is difficult to set a searching criteria.

The invention is made to solve the above described problem, and an object of the invention is to provide a pattern matching technique capable of accurately searching the testing point while simplifying effort of a presetting.

### Solution to Problem

The pattern matching method related to the invention is that an image region of a part of a captured image is extracted, a divisional image of the image region is set as a template image, and a pattern matching is performed while rotating the template image. Moreover, it is determined whether a point-symmetric pattern exists inside the image region by the pattern matching.

### Advantageous Effects of Invention

According to the pattern matching related to the invention, a presetting work for setting a proper template by a test staff in advance is simplified to be able to accurately search the testing point.

The other objects, features and advantages of the invention will become apparent from the following description of the embodiments of the invention taken in conjunction with the accompanying drawings.

### BRIEF DESCRIPTION OF DRAWINGS

FIG. 1 is a flowchart for explaining a procedure of a pattern matching method related to a first embodiment;

FIG. 2 is a diagram showing an image, captured by a microscope, of a silicon wafer part forming a fine circuit pattern of a test targeted electronic device;

FIG. 3 is a diagram showing for explaining an evaluation window of performing the pattern matching for a captured image;

FIG. 4 is a diagram for explaining of a template inside an evaluation window 301;

FIG. 5 is a diagram for explaining a procedure of calculating a matching score inside the evaluation window 301 by using a template image;

FIG. 6 is a diagram showing a result, as a score map, performed by the first embodiment related pattern matching method for the captured image shown in FIG. 2 and FIG. 3;

FIG. 7 is a flowchart for explaining a procedure of the pattern matching method related to a second embodiment;

FIG. 8A is a diagram showing an aspect of scanning the captured image in a horizontal direction;

FIG. 8B is a diagram showing an aspect of scanning the captured image in a perpendicular direction;

FIG. 9 is a diagram showing an example of a masked image acquired from masking part of no scribe line;

FIG. 10 is a flowchart for explaining a procedure of the pattern matching related to a third embodiment;

FIG. 11A is a diagram showing a screen image in setting a virtual evaluation window by a test staff;

FIG. 11B is a diagram showing the screen image in enlarging the virtual evaluation window by the test staff;

FIG. 12 is a diagram for explaining an operation example when a part of a point-symmetric pattern existing inside the evaluation window 301 is identified to some extent;

FIG. 13A is a diagram showing an interval difference of the scribe line dependent on a capturing magnification ratio difference;

FIG. 13B is a diagram showing the interval difference of the scribe line dependent on the capturing magnification ratio; and

FIG. 14 is a configuration diagram of an electronic device testing apparatus 1000 for testing electronic devices by using the pattern matching method described in the first to sixth embodiments.

### DESCRIPTION OF EMBODIMENTS

### Embodiment 1

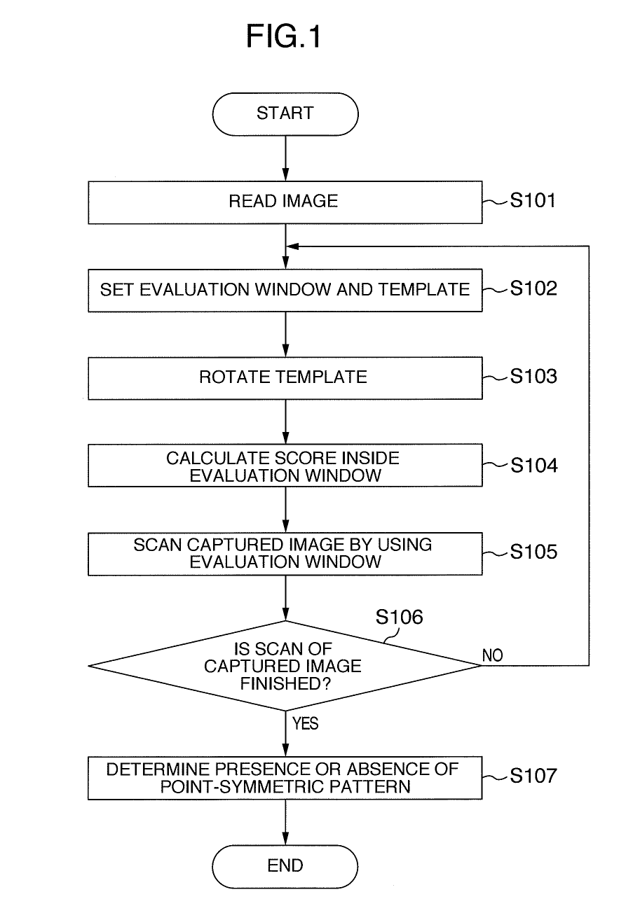

FIG. 1 is a flowchart for explaining a procedure of a pattern matching method related to a first embodiment of the invention.

The procedure in the flowchart shown in FIG. 1 indicates a technique of the pattern matching to be used for capturing an electronic device by an image capturing device, such as an optical microscope etc., for testing a testing point by using a captured image. This procedure can be executed by an electronic computer after received the captured image, which is also the same as the following embodiments.

Here, the electronic device means a device, such as a semiconductor device to be a test target.

The electronic computer provides an arithmetic device, a captured image input unit, an image display unit and an operation input unit.

The arithmetic device is configured by a CPU (Central Processing Unit), a microcomputer, etc. to execute the pattern matching method shown in the flowchart in FIG. 1.

The captured image input unit receives the captured image.

The image display unit is configured by a device, such as a display etc. for displaying a result etc. of the pattern matching on a screen.

The operation input unit is means that performs an operation input by an operator.

Hereinafter, steps in the procedure will be described with reference to FIG. 1.

(Step S101 in FIG. 1)

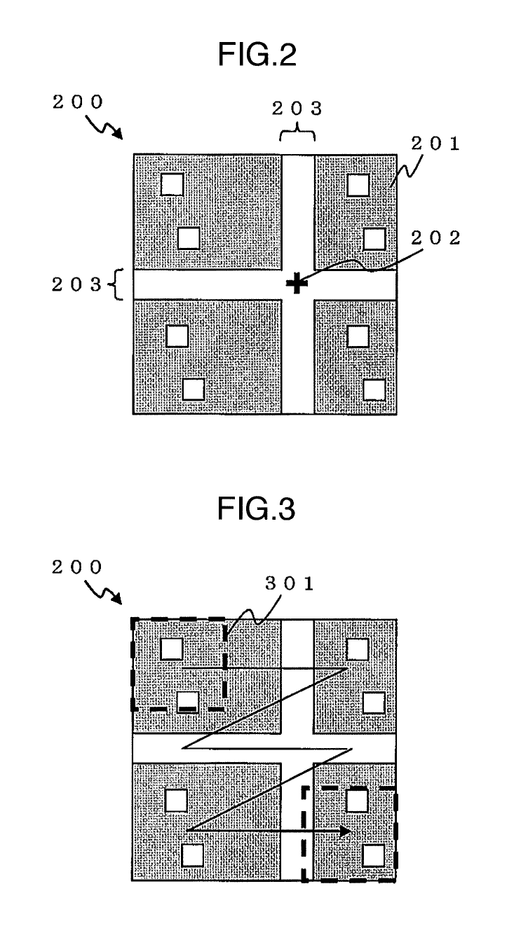

The arithmetic device in the above-described electronic computer (hereinafter, referred simply to as arithmetic device) acquires the captured image acquired by capturing a test targeted part of the electronic device via the captured image input unit. The captured image contains a cross point at which scribe lines are intersected, as described later with reference to FIG. 2.

(Step S102 in FIG. 1)

The arithmetic device sets an evaluation window 301, as described later with reference to FIG. 3, and also sets a part of the evaluation window 301 as a template. This template is used for when it is determined whether a point-symmetric pattern exists inside the evaluation window 301, which will be described in detail with reference to FIG. 3.

(Step S103 in FIG. 1)

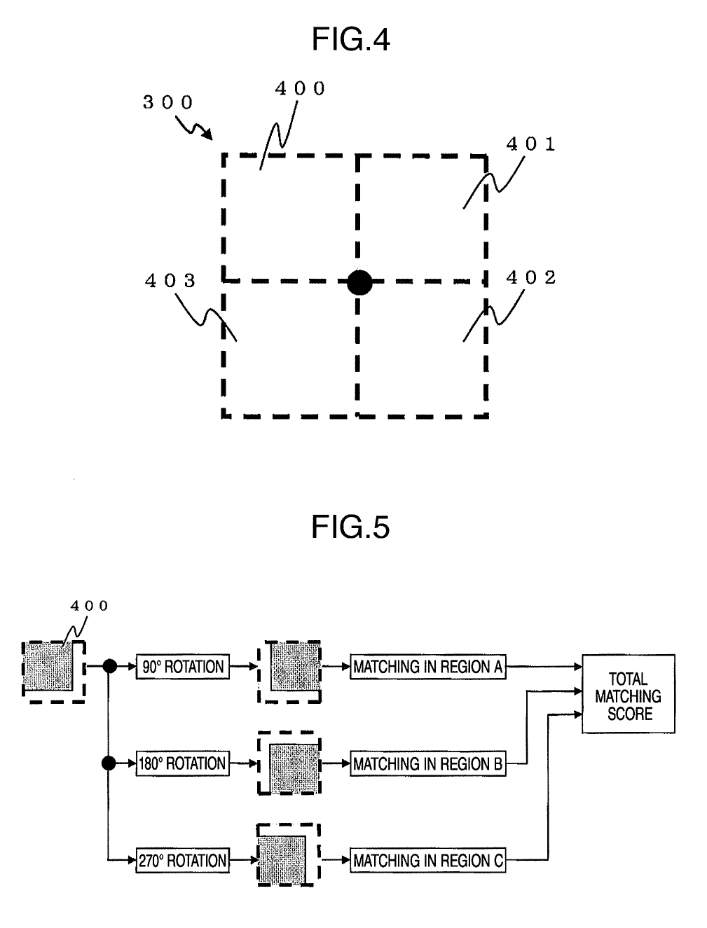

The arithmetic device rotates the template set at the step S102 to generate template rotated images, as described later with reference to FIG. 4 and FIG. 5.

(Step S104 in FIG. 1)

The arithmetic device performs the pattern matching between the template rotated images and the parts of images inside the evaluation window 301 corresponding to a position at which the template was rotated, as described later with reference to FIG. 5. Further, the arithmetic device calculates a matching score evaluated with its matching result by a predetermined arithmetic expression etc. to thereby calculate a total matching score for the entire evaluation window 301 by using the matching score for the respective template rotated images.

(Step S105 in FIG. 1)

The arithmetic device scans the captured image, while moving the evaluation window inside the captured image, to calculate the above-described matching score in the entire region of the captured image.

(Step S106 in FIG. 1)

The arithmetic device determines whether the entire region of the captured image is scanned by using the evaluation window 301. If the scan for the entire region is completed, the processing proceeds to a step S107, and returns to the step S102 to repeat the same processing unless it is completed.

(Step S107 in FIG. 1)

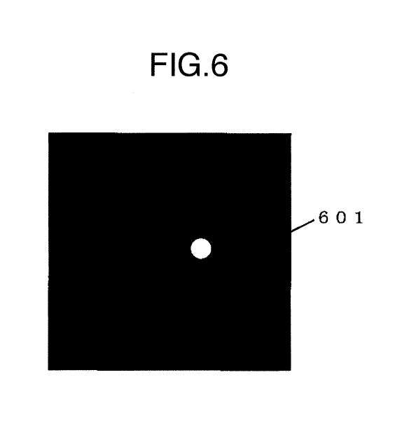

The arithmetic device determines whether the point-symmetric pattern exists inside the captured image on the basis of the matching score calculated at the steps S102 to S105, as described later with reference to FIG. 6.

The flowchart for the pattern matching method related to the first embodiment has been described above.

Next, the detail of respective steps will be described with reference to FIG. 2 to FIG. 6.

FIG. 2 is a diagram showing an image, captured by the microscope, of a part of silicon wafer forming a fine circuit pattern of a test targeted electronic device.

In FIG. 2, a captured image 200 of the silicon wafer has chips 201, and a scribe line 203 exists as a barrier for the chips on the silicon wafer. A part of center 202 (cross point 202) at which the scribe lines 203 are intersected becomes a search target of the pattern matching. This is because it is assumed that the point-symmetric pattern exists centering around the cross point 202.

In addition, a crisscross mark shown in FIG. 2 is appended thereto for explicitly explaining the cross point 202, but does not exist practically on the scribe line 203.

FIG. 3 is an explanatory diagram of the evaluation window for performing the pattern matching of the captured image. The arithmetic device selects the image region of a part of the captured image to set it as the evaluation window 301.

The evaluation window 301 is a square region cut out a part from the captured image. The shape of evaluation window 301 is unnecessarily limited to the square, but the pattern matching may be performable by using the template rotated image as described later.

The evaluation window 301 can also be said that it is an evaluation unit for determining whether the point-symmetric pattern exists. That is, the arithmetic device does not determine whether the point-symmetric pattern exists by evaluating the entire captured image once, but evaluates whether the point-symmetric pattern exists inside the evaluation window 301 cut out a part of the captured image. The arithmetic device scans the captured image for every evaluation window 301 unit while moving the position of evaluation window 301.

The arithmetic device scans eventually the entire captured image by using the evaluation window 301 to evaluate whether the point-symmetric pattern exists inside the captured image.

An initial position of the evaluation window 301 is set as a vertex at the left-top of the captured image, for example. First, the arithmetic device moves the evaluation window 301 of one pixel at a time in a right direction to scan the captured image. A scan position is then moved by one pixel to a lower side at a time when the scan position reaches to a right end, and the scan is performed again from a left end of the captured image. The arithmetic device repeats the same procedure afterward.

In addition, it is not indispensable to scan all parts of captured image by using the evaluation window 301 when the pattern matching is performed only for the part of captured image.

FIG. 4 is a diagram for explaining the template inside the evaluation window 301.

In the first embodiment, the arithmetic device sets a region of a part inside the evaluation window 301 as a template image to be used for determining whether the point-symmetric pattern exists inside the evaluation window 301.

Here, the evaluation window 301 is divided into four square regions, centering around its center, and either divided image is used as a template image, as an example, but a dividing method of evaluation window 301 is not limited thereto.

That is, if the template image is rotated around a center point, as a criteria, of the evaluation window 301 to be able to detect the point-symmetric pattern, any type of the dividing method may be used.

FIG. 5 is an explanatory diagram of the procedure for calculating the matching score inside the evaluation window 301 by using the template image. Here, the divided image shown in the left-upper part described in FIG. 4 is used as a template image, but either divided image set as the template image is not limited thereto.

The arithmetic device sets the divided image of the left-upper part in FIG. 4 as the template image, thereafter, rotates the template image clockwise 90, 180 and 270 degrees to thereby generate three images. These three images are referred to as template rotated images, respectively.

The arithmetic device performs the patter matching between the above-described three template rotated images and the right-upper part, right-lower part and the left-lower part of the evaluation window 301, respectively. The pattern matching performed at this time corresponds to that performing between the template rotated images and the divided image corresponding to the respective rotated positions of after rotated the template rotation image.

This is dependent on a high possibility of coinciding mutually between the template rotated image and the divided image corresponding to the position after rotated it, when the point-symmetric pattern based on the center, as a criteria, of evaluation window 301 exists inside the evaluation window 301.

In addition, any known art can be used for the pattern matching method inside the evaluation window 301, at this time. For example, an image correlation method having been utilized generally in industrial field can be used.

A result performed for the pattern matching is acquired as a matching score by using an evaluation function etc. according to pattern matching techniques. Here, the higher the matching score, the higher the coincidence degree between them becomes.

The arithmetic device calculates a summation of the matching scores acquired by performing the pattern matching between the respective template rotated images and the divided image corresponding to the positions after rotated. This summation is set as a total matching score of the evaluation window 301.

In addition, an index value statistical of such as a dispersion value, average value, etc. of the respective matching scores can be set as the total matching score of the evaluation window 301, as substitute for the summation of the respective matching scores.

When the center of evaluation window 301 is a cross point, the coincidence degree between the respective template rotated images and the respective divided images of the right-upper part (region A401), the right-lower part (region B402) and the left-lower part (region C403) in the evaluation window 301 becomes mutually high. In this case, the total matching score of evaluation window 301 becomes high.

FIG. 6 is a diagram showing the result, as a score map, performed of the pattern matching method for the captured image shown in FIG. 2 and FIG. 3 related to the first embodiment.

Here, an example shows that the total matching score of the evaluation window 301 is represented by colors in the order of scan by using the evaluation window 301. The part of which the total matching score is high is represented by white, and the part of which the total matching score is low is represented by black.

In the example shown in FIG. 6, it is understood that the total matching score is highest at a position 601 corresponding to the cross point 202.

The arithmetic device determines that the point-symmetric pattern exists inside the part at which the total matching score is high. For example, it may determine that the point-symmetric pattern exists inside the part at which the total matching score is equal to or greater than a predetermined threshold value, and it may also determine that the point-symmetric pattern exists only inside the part at which the total matching score is highest.

The detail of pattern matching method related to the first embodiment has been described above. According to the first embodiment, the arithmetic device scans the captured image acquired by capturing the test targeted electronic device, while moving the evaluation window 301, to determine whether the point-symmetric pattern exists inside the captured image.

Further, the arithmetic device sets one of the divided images acquired by dividing the part of evaluation window 301 in a template image used for determining whether the point-symmetric pattern exists inside the evaluation window 301.

This enables to simplify the procedure of pattern matching since it is unnecessary to set the template image by the test staff in advance.

Further, according to the first embodiment, the arithmetic device rotates the template image to 90, 180 and 270 degrees to generate three template rotated images, respectively, and the pattern matching is performed for between the respective template rotated images and the divided images of the right-upper part (region A401), right-lower part (region B402) and left-lower part (region C403) in the evaluation window 301.

This enables to accurately determine whether the point-symmetric pattern based on the center, as a criteria, of the evaluation window 301 exists inside the evaluation window 301.

### Embodiment 2

In a second embodiment, a method of enhancing the effect of pattern matching will be described by eliminating elements to be adversely affected on the matching score of the pattern matching. In addition, the method to be described in the second embodiment may be used together with that described in the first embodiment, or may also be used independently.

The captured image shown in FIG. 2 in the first embodiment is pointed out as an example of the captured image containing the elements to be adversely affected on the matching score of the pattern matching. A rectangle pattern also exists in the captured image other than the scribe line 203.

It is desirable that such pattern other than the scribe line is removed since it adversely affects on the matching score when searching the point-symmetric pattern by the pattern matching.

As below, a method of searching the point-symmetric pattern will be described by removing the pattern to be adversely affected on such matching score from the captured image.

In addition, the following (Condition 1) to (Condition 3) are assumed in the second embodiment.

(Condition 1) The point-symmetric pattern as a search target exists such that it straddles over the upper, lower, left and right of the captured image, such as the scribe line.

(Condition 2) The pattern is configured by a straight line.

(Condition 3) A nonpoint-symmetric pattern (pattern other than the scribe line) has a condition different from the above-described point-symmetric pattern.

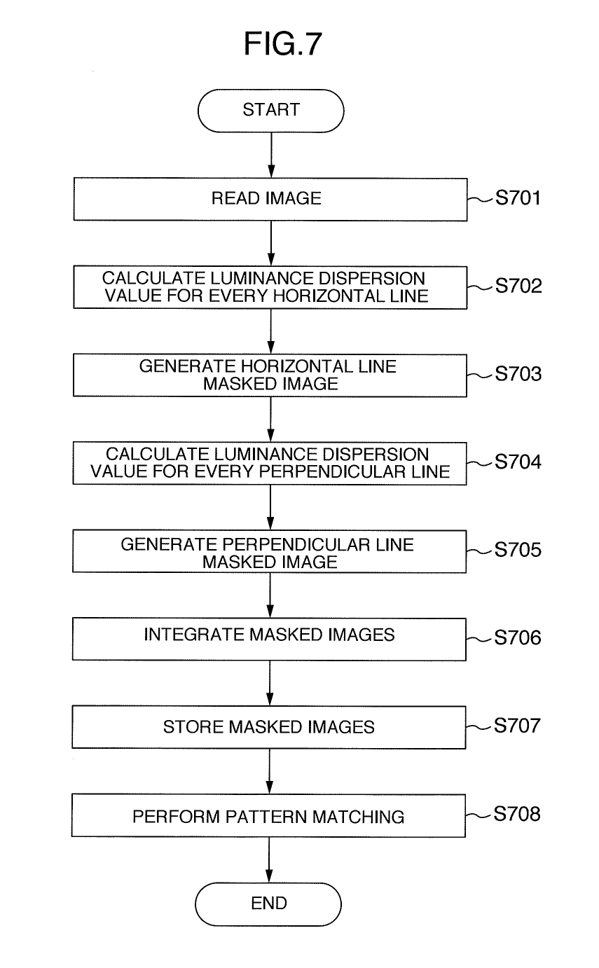

FIG. 7 is a flowchart for explaining the procedure of the pattern matching method related to the second embodiment. The procedure in the flowchart in FIG. 7 can be executed by the electronic computer etc. providing the same configuration described in the first embodiment. Steps in FIG. 7 will be described below.

(Step S701 in FIG. 7)

The arithmetic device acquires the captured image acquired by capturing the test targeted part of electronic device via the captured image input unit. This captured image contains the cross point as the same as that in the first embodiment.

(Step S702 in FIG. 7)

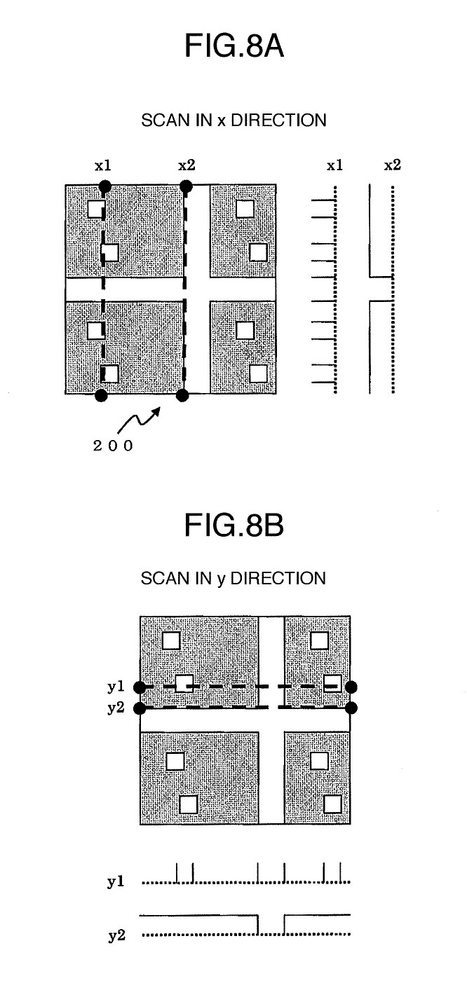

The arithmetic device scans the captured image in a horizontal direction to calculate a luminance dispersion value of pixels on scanning lines for every scanning line, as described later with reference to FIG. 8.

(Step S703 in FIG. 7)

The arithmetic device determines that the scan performs for the part which is not the scribe line, when the luminance dispersion value calculated at the step S702 is equal to or greater than an after-described luminance dispersion threshold value, as described later with reference to FIG. 8. Next, the arithmetic device masks the part, which is not the scribe line, to generate a horizontal line masked image.

Here, the mask means that the captured image is corrected by deleting the part, varying the color or luminance, etc. in such a way that the part, which is not the scribe line, does not emerge on the image.

(Step S704 in FIG. 7)

The arithmetic device scans the captured image in a perpendicular direction to calculate the luminance dispersion value of the pixels on the scanning lines for every scanning line, as described later with reference to FIG. 8.

(Step S705 in FIG. 7)

The arithmetic device determines that the scan performs the part which is not the scribe line, when the luminance dispersion value calculated at the step S704 is equal to or greater than an after-described luminance dispersion threshold value, as described later with reference to FIG. 8. Next, the arithmetic device masks the part, which is not the scribe line, to generate a perpendicular line masked image.

(Step S706 in FIG. 7)

The arithmetic device refers to the horizontal line masked image and perpendicular line masked image generated at the steps S702 to S705 to extract only the images on the scanning lines assumed as the scribe line in either one of the images.

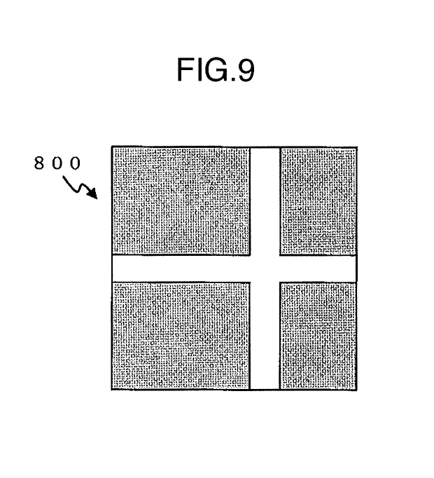

Next, the arithmetic device superimposes the image of part assumed as the scribed line on a horizontal scanning line with the image assumed as the scribe line on the perpendicular scanning line to integrate them and generate an integrated masked image. In this way, the image of scribe line in the horizontal and perpendicular directions is only remained, as described later with reference to FIG. 9.

(Step S707 in FIG. 7)

The arithmetic device stores the masked image generated at the step S706 in a storage device, such as a memory etc.

(Step S708 in FIG. 7)

The arithmetic device uses the masked image stored at the step S707 to perform the pattern matching for searching the testing point. The pattern matching method in this case may be of that described in the first embodiment, and other pattern matching methods may also be used. For example, a generally known pattern matching method can be used.

The flowchart of pattern matching method related to the second embodiment has been described above.

Next, the detail of the steps S703 and S705 will be described with reference to FIGS. 8A, 8B to FIG. 9.

FIG. 8A and FIG. 8B are diagrams showing an aspect of scanning the captured image in the horizontal and perpendicular directions. In FIG. 8A and FIG. 8B, the scribe line exists such that it straddles over the upper, lower, left and right of a screen displaying the captured image. Furthermore, plural pieces of rectangle shaped pattern exist around the scribe line.

In FIG. 8A and FIG. 8B, the captured image is scanned in the perpendicular direction at positions x1 and x2, and the luminance of pixel at the positions on the scanning line is indicated, respectively, as X1 and X2 on the right side of FIG. 8A represented as one-dimensional graphic (referred to as image profile).

A scanning line x1 is intersected with four rectangle shaped patterns and the scribe line in the horizontal direction, therefore, a luminance distribution of the pixels on the scanning line becomes discrete. In contrast, a scanning line x2 lies alongside the scribe line in the perpendicular direction, therefore, the luminance distribution of the pixels on the scanning line becomes uniformity.

Likewise, in FIGS. 8A and 8B, the captured image is scanned in the horizontal direction at positions y1 and y2, and the luminance of pixel at the positions on the scanning line is indicated, respectively, as Y1 and Y2 on the lower side of FIG. 8B represented as one-dimensional graphic (image profile).

A scanning line y1 is intersected with two rectangle shaped patterns and the scribe line in the perpendicular direction, therefore, the luminance distribution of the pixels on the scanning line becomes discrete. In contrast, a scanning line y2 lies alongside the scribe line in the horizontal direction, therefore, the luminance distribution of the pixels on the scanning line becomes uniformity.

The image profile acquired by scanning the part configuring the nonpoint-symmetric pattern, such as on the scanning lines x1 and y1, has a large luminance variation compared with that acquired by scanning the part configuring the point-symmetric pattern, such as on the scanning lines x2 and y2. That is, the pixels on the scanning lines x2 and y2 have a large luminance dispersion value.

The arithmetic device specifies the position of scribe line and the position of part which is not the scribe line, by using the above-described aspect, at the steps S703 and S705 in FIG. 7, so that the part, which is not the scribe line, can be masked.

For example, the arithmetic device calculates the luminance dispersion value of pixels on the respective scanning lines to determine that the scanning line, the part of which is not the scribe line, is scanned, when the luminance dispersion value is equal to or greater than a predetermined luminance dispersion threshold value. This luminance dispersion threshold value may be used of a common value for the horizontal and perpendicular scanning lines, and may also be used of an individual value.

FIG. 9 is a diagram showing an example of the masked image acquired by masking the part which is not the scribe line. In the masked image shown in FIG. 9, the rectangle shaped pattern around the scribe line is masked, and it is understood that the scribe line is only remained.

In addition, the luminance dispersion threshold value for determining whether the scribe line is a targeted one by using the luminance dispersion value, may be set arbitrarily by the test staff etc., and it may also be set by this setting when acquiring design data etc. of the electronic device.

The detail of the pattern matching method in the second embodiment has been described above. As above, according to the second embodiment, the arithmetic device scans the captured image in the horizontal and perpendicular directions to calculate the luminance dispersion value of the pixels on the scanning lines to be able to determine that the scanning line, the part of which is not the scribe line, is scanned, when the luminance dispersion value is equal to or greater than the predetermined luminance dispersion threshold value.

In this way, the masked image masked for the part, which is not the scribe line, can be acquired to therefore suppress an influence on the matching score of the pattern matching caused by the part which is not the scribe line, so that the pattern matching can be performed more accurately. In consequence, the testing point of the electronic device can be searched more accurately.

Further, the pattern matching method related to the second embodiment is additionally used together with that described in the first embodiment, so that an advantage of the pattern matching method related to the first embodiment can be acquired.

### Embodiment 3

In a third embodiment of the invention, the pattern matching method will be described such that a reference image for performing the pattern matching can be selected by the test staff etc. The description will also be concerned with the case where a condition in performing the pattern matching is optimized by matching with the selected reference image.

In addition, in the third embodiment, an innovation is provided for the test staff adapted to the known pattern matching technique in such a way that he/she does not become awake of differences for the pattern matching method. Specifically, the arithmetic device performs a processing for correcting a reporting format made matched with the known pattern matching technique when reporting a pattern matching result. The detail thereof will be described later.

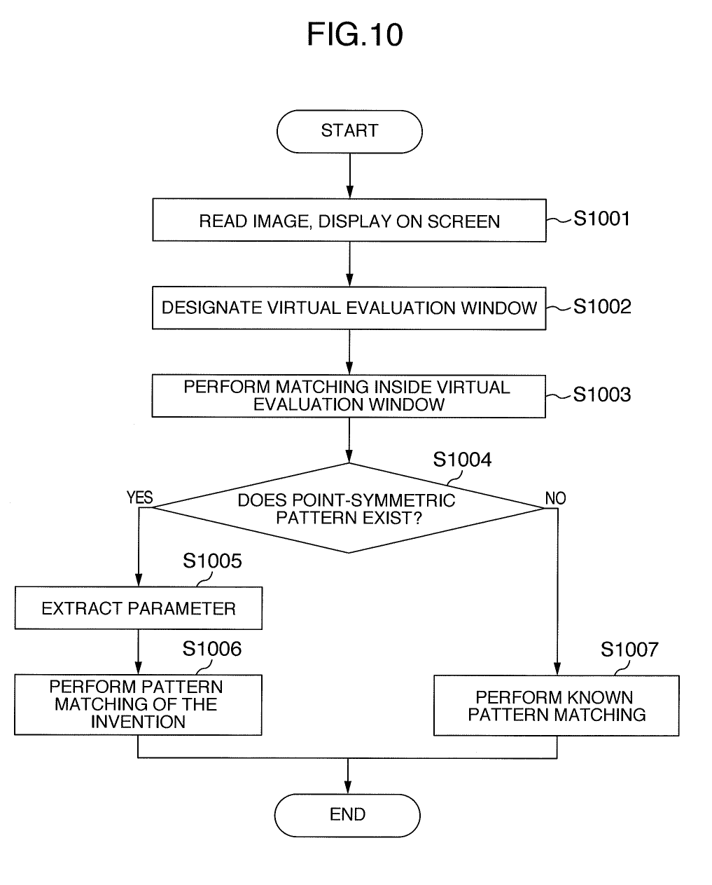

FIG. 10 is a flowchart for explaining the procedure of pattern matching method related to the third embodiment. The procedure in the flowchart shown in FIG. 10 can be executed by the electronic computer etc. providing the same configuration as that described in the first and second embodiments. Steps shown in FIG. 10 will be described below.

(Step S1001 in FIG. 10)

The arithmetic device acquires the above-described captured image captured of the test targeted part of electronic device via the captured image input unit. This captured image contains the cross point as the same as that in the first embodiment. The arithmetic device makes display the acquired captured image on the image display unit.

(Step S1002 in FIG. 10)

An operator such as test staff operates the operation input unit of computer to designate a virtual evaluation window region (designated region). The arithmetic device receives its region designation to acquire a coordinate of the region. This step corresponds to a step for designating a matching template in the known pattern matching technique.

The test staff adapted to the known pattern matching technique has an assumption that the region designated by this step is used for the pattern matching as matching template without change.

Practically, the arithmetic device receives the region designation at this step to then handle this region as a virtual evaluation window, as described with the following steps.

(Step S1003 in FIG. 10)

The arithmetic device searches whether the point-symmetric pattern exits inside the virtual evaluation window designated at the step S1002. Specifically, it is considered that the following search procedure can be used, for example.

(Step S1003 of search procedure 1 in FIG. 10)

The arithmetic device generates the template rotated image, as set the left-upper part as the template image inside the virtual evaluation window, as described in the first embodiment, to then perform the pattern matching.

(Step S1003 of search procedure 2 in FIG. 10)

The arithmetic device performs the above-described step (search procedure 1) under several different conditions while varying conditions, such as the size of virtual evaluation window and of the template image.

(Step S1003 of search procedure 3 in FIG. 10)

As a result of the search procedures 1 and 2, the arithmetic device determines that the point-symmetric pattern exists inside the virtual evaluation window when it meets a part at which the matching score is equal to or greater than a matching score threshold value.

(Step S1004 in FIG. 10)

The processing proceeds to a step S1005 if the point-symmetry is met at the step S1003, and to a step S1007 unless it is detected.

(Step S1005 in FIG. 10)

The arithmetic device extracts the condition of the virtual evaluation window size etc. at this time, as a parameter to be used in performing the pattern matching at the following steps, when meeting the point-symmetric pattern inside the virtual evaluation window at the step S1003.

(Step S1006 in FIG. 10)

The arithmetic device performs either the pattern matching described in the first or second embodiment by using the parameter extracted at the step S1005.

At this time, the arithmetic device may use the pattern matching method described in either the first or second embodiment without change, and may also use only a technique of performing the matching by generating the template rotated image inside the evaluation window 301.

In the case of using the latter technique, the arithmetic device determines whether the image of virtual evaluation window set at the step S1002 is coincided with that of the evaluation window 301 by generating the template rotated image inside the evaluation window 301 to then perform the matching.

(Step S1007 in FIG. 10)

The arithmetic device performs the pattern matching adapted to a generally used technique, such as the known pattern matching method etc. by using the virtual evaluation window designated by the test staff at the step S1002. In this case, the arithmetic device searches a part coincided with the image inside the virtual evaluation window from inside the capture image.

The procedure of pattern matching method related to the third embodiment has been described above. Next, the following description will be concerned with differences of result report in response to the difference of pattern matching techniques.

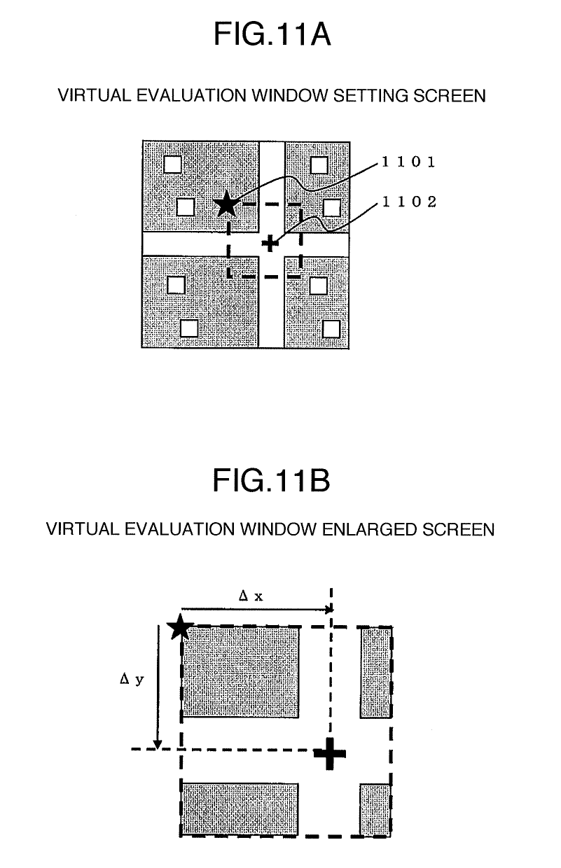

FIGS. 11A, 11B are diagrams showing a screen image when setting the virtual evaluation window by the test staff. FIG. 11 A is a targeted screen image, and FIG. 11B is a screen image enlarged with the virtual evaluation window.

In FIGS. 11A, 11B, a cross point 1102 exists inside the evaluation window. At this time, a left-upper coordinate 1101 on the evaluation window is represented by a star-shaped mark.

In the generally used pattern matching technique, the test staff designates an image pattern, as a region, to be searched on the screen. At this time, it is general that the test staff designates the left-upper coordinate and a vertical and horizontal size on the screen.

When the image pattern coincided with the image region designated by the test staff is met inside the captured image, it is general that the left-upper coordinate of the image region containing its portion or the coordinate corresponding to the left-upper coordinate 1101 in FIGS. 11A, 11B, is reported as a searched result. This is because the above-described designating method is coincided with the report format of searched result.

In contrast, in the pattern matching technique described in the third embodiment, the position of cross point 1102 is reported as a pattern matching result.

Therefore, the test staff adapted to the known pattern matching technique has an assumption that the left-upper coordinate 1101 of the evaluation window is reported as the searched result, when the cross point 1102 is met inside the evaluation window.

The test staff possibly misidentifies the cross point 1102 as being the left-upper coordinate of evaluation window if the coordinate of cross point 1102 is reported as a test result.

Therefore, in the third embodiment, the arithmetic device performs the pattern matching at the step S1006 in FIG. 10 to calculate a difference (Δx, Δy) between the coordinate of the point-symmetric pattern and the left-upper coordinate of evaluation window in advance, when the point-symmetric pattern is met inside the evaluation window.

The arithmetic device indicates the coordinate indicating that the difference (Δx, Δy) is added to a central coordinate of the actual point-symmetric pattern (cross point 1102), when indicating the pattern matching result by displaying it on a computer screen.

In this way, the report formats of searched result are integrated for the cases of performing the processing at the step S1006 and S1007 in FIG. 10. Therefore, the test staff can take hold of the pattern matching result according to the known report format without becoming awake of internally differences of pattern matching techniques.

In the step S1002 in FIG. 10, it has been described that the test staff designates the virtual evaluation window on the screen. In replacement of this, the virtual evaluation window may be designated on design data when acquiring the design data of electronic device.

As described above, in the third embodiment, the pattern matching technique is varied by determining whether the point-symmetric pattern exists inside the image region (virtual evaluation window) designated inside the captured image by a user.

When the point-symmetric pattern exists, the pattern matching technique of either the first or second embodiment is used at the step S1006 in FIG. 10, so that the same advantage as that in these embodiments can be maintained.

Further, when the point-symmetric pattern does not exist, the generally known pattern matching technique is used at the step S1007 in FIG. 10, therefore, it is unnecessary to interrupt the pattern matching even when the technique of either the first or second embodiment cannot be used.

In the third embodiment, whether the point-symmetric pattern exists inside the image region (virtual evaluation window) designated inside the captured image by the user, can be determined by using the technique same as the search method inside the evaluation window described in the first embodiment.

In this way, it can reliably be determined whether the point-symmetric pattern is present or absent.

In the third embodiment, plural times of search are also performed while varying the parameter, such as the size of virtual evaluation window, when determining whether the point-symmetric pattern exists inside the image region (virtual evaluation window) designated inside the captured image by the user.

In this way, the parameter in performing the pattern matching at a later step can be made optimized by coinciding with the virtual evaluation window designated by the user.

In the third embodiment, the arithmetic device also indicates, as a searched result, the position adding the above-described (Δx, Δy) to the central position of the point-symmetric pattern, when the point-symmetric pattern is met by performing the pattern matching method described in the first and second embodiments.

In this way, the test staff adapted to the known pattern matching method can take hold of the pattern matching result according to the known report format, without becoming awake of the internally performed pattern matching method. Therefore, a situation can be avoided such that the test staff misidentifies the searched result by causing the difference of pattern matching techniques.

### Embodiment 4

In a fourth embodiment, a description will be concerned with a technique of simplifying the processing for when determining whether the point-symmetric pattern exists inside the evaluation window.

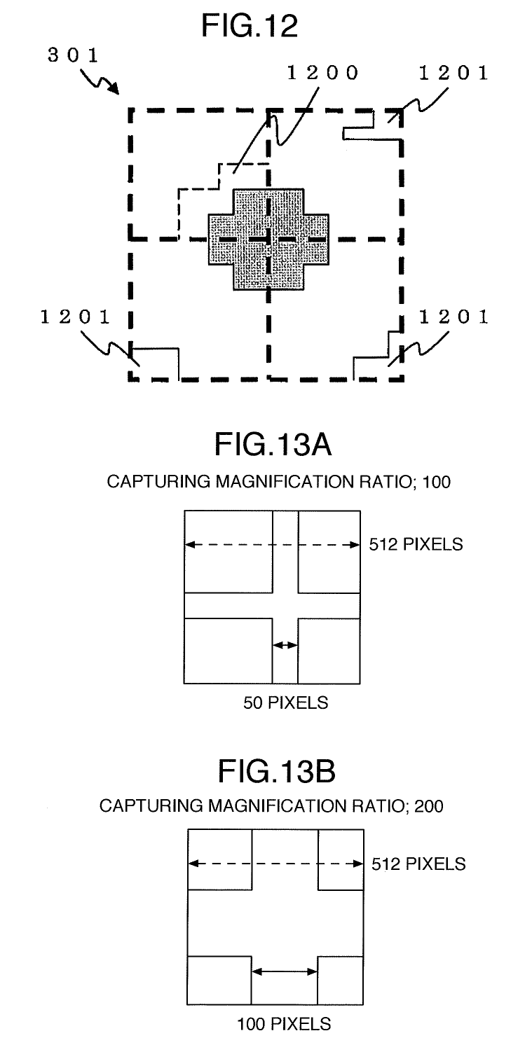

FIG. 12 is a diagram for explaining an operation example of when a part inside which the point-symmetric pattern exists in the evaluation window 301, is identified to some extent.

The position at which the point-symmetric pattern exists inside the captured image is also understandable previously to some extent when the design data of test targeted electronic device can be acquired beforehand. In such cases, the processing for calculating the total matching score of evaluation window 301 can be simplified.

In FIG. 12 for example, it is sufficient that the pattern matching is only performed for near the center of evaluation window 301 when the existence of point-symmetric pattern at near the center of evaluation window 301 is understandable beforehand. Therefore, the arithmetic device sets a partial evaluation region 1200 inside the evaluation window 301 to perform the pattern matching of only this inside.

In this way, it is unnecessary to calculate the matching for all of the pixels inside the evaluation window 301 by the arithmetic device, therefore, the processing is simplified for calculating the total matching score of evaluation window 301, so that a processing load can be reduced.

When the nonpoint-symmetric pattern 1201 exists inside the evaluation window 301, the influence on the matching score from the nonpoint-symmetric pattern 1201 can be suppressed by performing the pattern matching only inside the partial evaluation region 1200.

In this way, it can reliably be determined whether the point-symmetric pattern exists inside the evaluation window 301.

In addition, the technique described in the fourth embodiment may be used together with that described in the first to third embodiments.

For example, in the first and second embodiments, the arithmetic device can use the technique of the fourth embodiment when calculating the total matching score of evaluation window 301.

In the third embodiment, likewise, the arithmetic device can use the technique of the fourth embodiment when calculating the total matching score of evaluation window 301. The arithmetic device sets the partial evaluation region 1200 inside the virtual evaluation window selected by the test staff to be able to perform the plural times of the pattern matching while varying the position, shape, size, etc. of the partial evaluation region 1200. At this time, the size of virtual evaluation window itself may also be varied together with the above, and only the partial evaluation region 1200 may also be varied independently.

### Embodiment 5

In a fifth embodiment, a description will be concerned with a technique acquired by calculating the luminance dispersion threshold value described in the second embodiment.

FIGS. 13A, 13B are diagrams showing an interval difference of the scribe line caused by a difference of a capturing magnification ratio.

Supposedly, the pixel size of image shown in FIGS. 13A, 13B is set in 512×512 pixels.

FIG. 13A shows an example of the captured image indicating that the capturing magnification ratio is 100, and FIG. 13B shows the same indicating that the capturing magnification ration is 200. It is assumed that the interval of scribe line is set in 50 pixels when the capturing magnification ratio is 100.

In the second embodiment, when the luminance dispersion threshold value is set, the interval of scribe line on the captured image is predicted by using the capturing magnification ratio in advance, and the luminance dispersion threshold value can be set on the basis of this prediction.

For example, the interval of scribe line is 130 μm in accordance with the design data of electronic device, it is assumed that the interval thereof is previously understood as 50 pixels when capturing the scribe line by the capturing magnification ratio of 100.

If the capturing magnification ratio is 200, the interval of scribe line should be 100 pixels on the screen in performing the technique of second embodiment. By using this, the luminance dispersion value on the image can be calculated. A value acquired by the above-calculation can be used as the luminance dispersion threshold value described in the second embodiment.

As described above, in the fifth embodiment, the luminance dispersion threshold value can be acquired from the calculation by using the design data of test targeted electronic device and the capturing magnification ratio of the captured image.

In this way, the arithmetic device can therefore set the luminance dispersion threshold value on the basis of the design data of electronic device, so that a proper mask image can be generated.

### Embodiment 6

One pattern matching technique may be combined with the other in the above-described embodiments 1 to 5.

In the third embodiment for example, both the techniques described respectively in the first and second embodiments are performed at the step S1006 in FIG. 10 together with the generally known pattern matching when the point-symmetric pattern is contained inside the virtual evaluation window designated by the test staff, and the matching scores acquired from the respective techniques may be averaged as a statistical processing to acquire a conclusive matching result. Or, the test staff may perform a determination on the basis of his/her experience by using the respective acquired matching scores.

### Embodiment 7

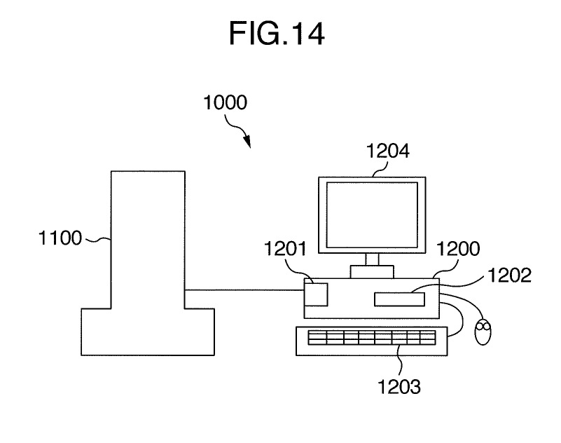

FIG. 14 is a configuration diagram showing an electronic device testing apparatus 1000 for testing electronic devices by using the pattern matching method described in the first to sixth embodiments.

The electronic device testing apparatus 1000 provides a microscope 1100 and an electronic computer 1200.

The microscope 1100 captures the test targeted electronic device to output its captured image to the electronic computer 1200.

The electronic computer 1200 provides a captured image input unit 1201, an arithmetic device 1202, an operation input unit 1203 and an image display unit 1204.

The captured image input unit 1201 is an interface for receiving the captured image from the microscope 1100. The specification of interface may be used of any known art.

The arithmetic device 1202 is configured by a CPU, a microcomputer, etc. and also provides a storage device, such as ROM (Read Only Memory) etc. The storage device stores programs defining the operation of pattern matching methods described in the first to sixth embodiments.

The arithmetic device 1202 performs the pattern matching method described in either the first to sixth embodiments in accordance with the operation defined by the program.

The operation input unit 1203 is an operation interface for performing an operation input for the electronic computer 1200 by the test staff etc.

The image display unit 1204 is configured by a liquid-crystal display device etc. The arithmetic device 1202 makes display a pattern matching performed result etc. on a screen of the image display unit 1204.

The microscope 1100 corresponds to the “capturing device” in the first to sixth embodiments.

The captured image input unit 1201 corresponds to the “captured image input unit” in the first to sixth embodiments.

The arithmetic device 1202 corresponds to the “arithmetic device” in the first to sixth embodiments.

The operation input unit 1203 corresponds to the “operation input unit” in the first to sixth embodiments.

The image display unit 1204 corresponds to the “image display unit” in the first to sixth embodiments.

The electronic device testing apparatus 1000 related to the seventh embodiment of the invention has been described as above.

It should be further understood by those skilled in the art that although the foregoing description has been made on embodiments of the invention, the invention is not limited thereto and various changes and modifications may be made in the spirit of the invention and the scope of the appended claims.

### INDUSTRIAL APPLICABILITY

According to the pattern matching method related to the invention, a presetting work for setting a proper template by the test staff in advance is simplified to be able to accurately search the testing point.

### REFERENCE SIGNS LIST

200 captured image of electronic device

201 chip

202 cross point

203 scribe line

301 evaluation window

400 template region

401 region A

402 region B

403 region C

601 matching score data

1100 microscope

1200 electronic computer

1201 captured image input unit

1202 arithmetic device

1203 operation input unit

1204 image display unit

1. A pattern matching method comprising:
a step of extracting a part of an image region from a captured image acquired by capturing an electronic device;
a step of dividing the image region based on a center position, as a criteria, of the image region to acquire two or more divided images;
a step of setting one of the divided images as a template image;
a template rotation step of rotating the template image based on the center position as the criteria to acquire two or more template rotated images;
a matching score calculation step of performing a pattern matching for between the template rotated images and images of parts corresponding to positions of after rotated the template rotated image of the image region to calculate a matching score of the pattern matching;
a total matching score calculation step of calculating an total matching score inside the image region by using the matching score for all of the template rotated images;
a step of acquiring the total matching score for plural parts of the captured image; and
a step of determining a part, inside which a point-symmetric pattern exists, in the captured image by using the total matching score for the plural parts of the captured image.

2. The pattern matching method according to claim 1 wherein,
at the template rotation step, the template image is rotated respectively to 90, 180 and 270 degrees to acquire the three template rotated images; and
at the total matching score calculation step, the pattern matching is performed for between the template rotated images and images of parts corresponding to positions of after rotated the template rotation image of the image region to 90, 180 and 270 degrees.

3. The pattern matching method according to claim 1 wherein,
at the total matching score calculation step, a summation value of the matching score inside the image region is used as an total matching.

4. A pattern matching method comprising:
a step of scanning a captured image acquired by capturing an electronic device to calculate a luminance dispersion value of pixels on a scanning line;
a step of replacing the pixels on the scanning line with uniformity when the luminance dispersion value is equal to or greater than a predetermined luminance dispersion threshold value; and
a step of performing a pattern matching by using the captured image of after replaced the a luminance value on the scanning line with a uniform value.

5. The pattern matching method according to claim 4 further comprising,
a step of calculating a predictive value of the luminance dispersion value of the pixels on the scanning line by using design data of the electronic device, and
a step of setting a calculated result as the luminance dispersion threshold value.

6. A pattern matching method comprising:
a region designation step of designating a designated region of a part of a captured image acquired by capturing an electronic device;
a determination step of determining whether a point-symmetric pattern exists inside the designated region by a pattern matching;
a pattern matching method decision step of deciding a pattern matching method in response to a presence or absence of the point-symmetric pattern; and
a step of performing the pattern matching for the captured image by using the pattern matching decided by the pattern matching method decision step.

7. The pattern matching method according to claim 6 wherein,
the determination step further includes:
a step of extracting an image region of a part from the designated region;
a step of dividing the image region based on a center position, as a criteria, of the image region to acquire two or more divided images;
a step of setting one of the divided images as a template image;
a template rotation step of rotating the template image based on the center position as the criteria to acquire two or more template rotated images;
a matching score calculation step of performing the pattern matching for between the template rotated images and images of parts corresponding to positions of after rotated the template rotation image of the image region to calculate a matching score of the pattern matching; and
a total matching score calculation step of calculating a total matching score inside the image region by using the matching score for all of the template rotated images.

8. The pattern matching method according to claim 7 wherein,
at the determination step,
the determination subjected to the pattern matching performs plural times while varying a size of the designated region or of the divided image, and
when a highest matching score acquired as a result of the pattern matching is equal to or greater than a predetermined matching score threshold value, a determination is made that the point-symmetric pattern exists inside the designated region.

9. The pattern matching according to claim 7 further comprising,
when the determination is made that the point-symmetric pattern exists inside the designated region at the determination step,
a step of extracting the image region of a part from the captured image by using the size of the designated region at that time,
the step of dividing the image region based on the center position, as the criteria, of the image region to acquire the two or more divided images,
the step of setting the one of the divided images as the template image,
the template rotation step of rotating the template image based on the center position, as the criteria, to acquire two or more template rotated images,
the matching score calculation step of performing the pattern matching for between the template rotated images and the images of the parts corresponding to the positions of after rotated the template rotation image of the image region to calculate the matching score of the pattern matching;
the total matching score calculation step of calculating the total matching score inside the image region by using the matching score for all of the template rotated images;
a step of acquiring the total matching score for plural parts of the captured image; and
a step of determining a part, inside which a point-symmetric pattern exists, in the captured image by using the total matching score for the plural parts of the captured image.

10. A pattern matching method comprising:
a region designation step of designating a designated region of a part of a captured image acquired by capturing an electronic device;
a determination step of determining whether a point-symmetric pattern exists in a part corresponding to an image region by using the image region; and
a step of performing a pattern matching of the captured image by using two or more types of pattern matching technique when determining that the point-symmetric pattern exists in the part corresponding to the image region at the determination step.

11. The pattern matching method according to claim 6 further comprising,
a step of indicating a coordinate at a left-upper vertex of an image region as a searched result when the point-symmetric pattern exists inside the image region.

12. The pattern matching method according to claim 6 wherein,
at the region designation step, the designation of the region for design data of the electronic device is received as substitute for the designation of the region for the part of the captured image when receiving the designation of the designated region.

13. The pattern matching method according to claim 1 wherein the pattern matching is performed only for a partial evaluation region, of the image region, inside which the point-symmetric pattern supposedly exists.

14. The pattern matching method according to claim 7 wherein,
at the determination step,
the pattern matching is performed only for a partial evaluation region, of the image region, inside which the point-symmetric pattern supposedly exists, and the determination subjected to the pattern matching performs plural times while varying a size of the partial evaluation region, and
when a highest matching score acquired as a result of the pattern matching is equal to or greater than a predetermined matching score threshold value, a determination is made that the point-symmetric pattern exists inside a part corresponding to the image region.

15. A pattern matching program wherein the pattern matching method written in claim 1 is executed by a computer.

16. An electronic computer comprising:
an arithmetic device that executes the pattern matching program written in claim 15; and
a captured image input unit that receives a captured image.

17. The electronic computer according to claim 16 further comprising,
an operation input unit that receives an operation input for designating a condition in performing a pattern matching method, and
a display unit that displays a performed result of the pattern matching method on a screen.

18. An electronic device testing apparatus comprising:
the electronic computer written in claim 16; and
a capturing device that captures an image of an electronic device.
